(19) United States
(12) Patent Application Publication
(10) Pub. No.: US 2004/0189172 A1
(43) Pub. Date: Sep. 30, 2004

(54) Array of barriers for flat panel displays and method for making the array of barriers

(76) Inventors: Zhaofu Hu, Beijing (CN); Pijin Chen, Beijing (CN); Liang Liu, Beijing (CN); Shou Shan Fan, Beijing (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/810,023

(22) Filed: Mar. 26, 2004

(30) Foreign Application Priority Data
Mar. 26, 2003 (CN) 03114071.8

(51) Int. Cl. H01J 1/88

(52) U.S. Cl. 313/292

(57) ABSTRACT

A method for making barrier arrays for use in flat panel displays includes the following steps: providing a metal plate; using photolithographic etching of the metal plate to form a shadow mask (21) having a number of openings defined therethrough according to a pixel pattern of a flat panel display; and forming an insulative layer (31) on the shadow mask. The technology for making a shadow mask is mature. In addition, a thickness and a material of the shadow mask can be selected according to the requirements of the flat panel display desired. Furthermore, the thickness and the material of the insulative layer can be determined according to the insulative performance required for the flat panel display. In summary, the present invention provides a barrier array having high precision at a low production costs. The barrier arrays are suitable for mass production in an environmentally friendly manner.

### BACKGROUND OF THE INVENTION

1. Field of the Invention

The present invention relates to flat panel displays, such as field emission displays and plasma displays. Specifically, the present invention relates to an improved array of barriers for such flat panel displays and a method for making the same.

2. Description of Prior Art

Flat panel displays, such as a typical plasma display panel or a typical field emission display, are well known as display devices capable of replacing a cathode-ray tube (CRT) since they have a small volume, low power consumption, and are suitable for mass production. An array of barriers is used to support and insulate pixels in such flat panel displays. To achieve superior display features, barrier array should be made have a flat upper surface, and the height of the barrier array should be uniform throughout the entire barrier array. Furthermore, the material of which the barrier array is made should not be porous to prevent air from being trapped in the pores thereof. Thus the method for manufacturing barrier array is critical in making flat panel displays.

The two main methods for making barrier array in the art are the screen printing method and the sandblasting method. In the screen printing method, each barrier array is formed by repeatedly screen printing and drying paste material on a substrate, and then baking the assembly. However, during the repeated printing and drying procedure, it is difficult to ensure that the array has a flat upper surface and uniform height, and this leads to increases in production costs. In addition, it is also difficult to fabricate the barrier array with high precision when using the screen printing method. Thus, screen printing is not suitable for mass production of high quality barrier array.

A sandblasting method is also widely used, in which material for the barrier array is applied to a substrate at a predetermined thickness, and then dried. Then a protective film having the shape of the desired barrier array is formed on the assembly, or a sand blasting mask is attached to the assembly. Sand is injected at high pressure so that unwanted portions of the assembly are removed, thus forming the barrier array. Finally, the barrier array is baked. However, the whole manufacturing process takes a considerable time, and control of the sand injection must be highly accurate. The sandblasting method is not very reliable, and is also prone to contaminate the manufacturing environment with sand.

Other methods for making barrier array for flat panel displays use photolithography, molding, and casting. However, all these methods require mating of a substrate with suitable pastes, as well as drying and baking processes. This makes these methods unduly time-consuming. Furthermore, it is difficult to fabricate barrier arrays with high precision using these methods.

### SUMMARY OF THE INVENTION

In view of the above-described drawbacks, an object of the present invention is to provide a barrier array for use in flat panel displays which has a flat upper surface and uniform height.

Another object of the present invention is to provide a barrier array for use in flat panel displays which is low cost and suitable for mass production.

A further object of the present invention is to provide a method for easily making high precision barrier array used in flat panel displays.

A still further object of the present invention is to provide a method for making high precision barrier array used in flat panel displays, the method being environmentally friendly.

In order to achieve the objects set out above, in one aspect of the present invention, a barrier array for use in a flat panel display in accordance with the present invention comprises a shadow mask defining a plurality of openings therethrough according to a predetermined pattern, and an insulative layer formed thereon. The predetermined pattern is in accordance with a pixel pattern of the flat panel display.

In order to achieve the objects set out above, in another aspect of the present invention, a preferred method of the present invention for making the above described barrier array comprises the following steps: providing a metal plate; using the metal plate to form a shadow mask by photolithographic etching, thereby defining a plurality of openings therethrough according to a predetermined pattern, which pattern is in accordance with a pixel pattern of a flat panel display; forming an insulative layer on the shadow mask. Because making a shadow mask is a mature technology in CRT, this method employs the mature technology. In addition, a thickness and a material of the shadow mask can be selected according to the particular requirements of the flat panel display desired. Furthermore, the thickness and the material of the insulative layer can be determined according to the insulative performance required for the flat panel display. Moreover, the barrier array may be produced a large enough size that it can be subdivided for use in a plurality of flat panel displays. In summary, the present invention provides barrier arrays having high precision and low production costs, and the barrier arrays are being suitable for mass production in an environmentally friendly manner.

Other objects, advantages and novel features of the present invention will become more apparent from the following detailed description when taken in conjunction with the accompanying drawings, in which:

### BRIEF DESCRIPTION OF THE DRAWINGS

FIG. 1 is a flowchart of the preferred method for making barrier array used in flat panel displays, according to the present invention;

FIG. 2 is a perspective view of a shadow mask formed according to the present invention;

FIG. 3 is a schematic diagram illustrating formation of an insulative layer on the shadow mask of FIG. 2 according to the preferred method;

FIG. 4 is a schematic top view of part of a barrier array formed according to the method of FIG. 1, said part comprising a single barrier; and

FIG. 5 is a cross-sectional view of the single barrier of the FIG. 4 taken along line V-V.

### DETAILED DESCRIPTION OF PREFERRED EMBODIMENTS OF THE INVENTION

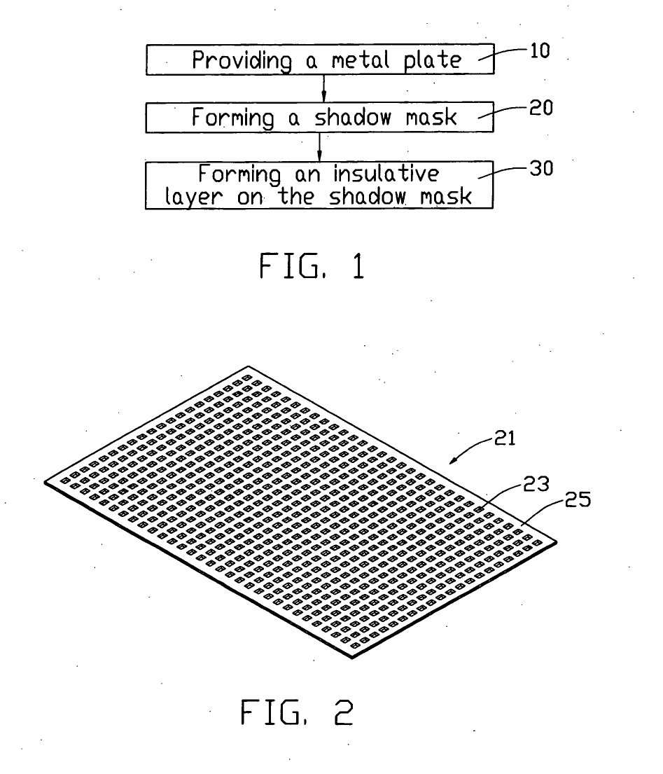

The preferred method for making barrier array used in flat panel displays according to the present invention will be described with reference to the flowchart of FIG. 1.

A metal plate is first provided (step 10). The metal plate can be made from invar (an alloy of iron and nickel), low carbon steel, or another suitable metal alloy that has a coefficient of thermal expansion matching that of a substrate of a flat panel display.

A mask is provided prior to forming a shadow mask. The mask has a predetermined pattern according to a pixel pattern of one or more desired flat panel displays. For the purposes of describing the present invention simply, it will be assumed hereafter that a pixel pattern for only one flat panel display is desired. The shadow mask 21 is then formed by photolithographic etching, using the mask (step 20). Referring to FIG. 2, the shadow mask 21 comprises the metal plate 25 and a plurality of openings 23 defined therethrough. The plurality of openings 23 are of sizes and are arranged in an array according to the pixel pattern of the flat panel display.

An insulative layer is then formed on the shadow mask (step 30). Generally, the insulative layer can be formed by electrophoretic deposition, spray coating or another suitable method. Preferably, the electrophoretic deposition method is employed. The insulative layer can be alumina, magnesia or another insulative material selected to meet a required insulative performance of the flat panel display. In the preferred method, alumina is used as the insulative material.

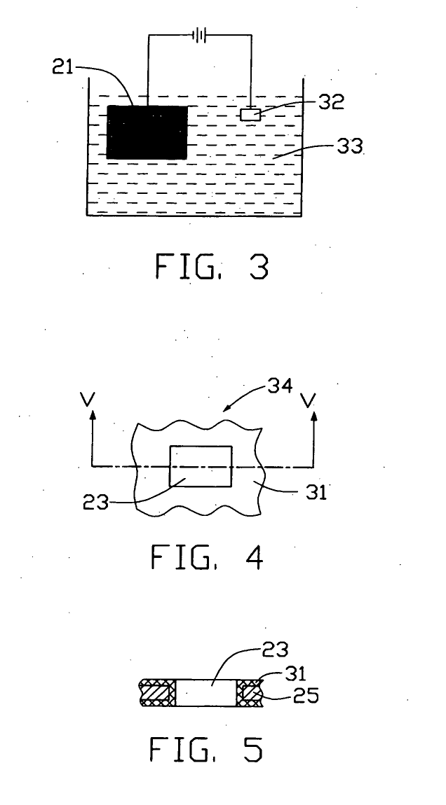

FIG. 3 is a schematic diagram showing an arrangement for deposition of an insulative layer on the shadow mask 21 according to the preferred method: The shadow mask 21 is used as an anode and metal aluminum 32 is used as a cathode. An electrolyte 33 comprises aluminum ions. In the preferred method, the electrolyte 33 comprises methyl alcohol (600 ml), magnesium sulfate (6 g), aluminum nitrate (30 ml), alumina (900 g) and deionized water (600 ml). The time needed for the electrophoretic deposition is determined by a required thickness of the insulative layer on the shadow mask 21, which in turn is determined according to a required insulative performance of the flat panel display.

The individual barrier 34 of which the barrier array is formed are completed once an insulative layer 31 of alumina material has been deposited on the shadow mask 21 to a predetermined thickness. Referring to FIG. 4, each barrier 34 comprises a part of the shadow mask 21 and the insulative layer 31 formed thereon. FIG. 5 shows a cross-sectional view of the barrier 34 of FIG. 4 taken along line V-V. The metal plate 25 and sides of an opening 23 of the barrier 34 are covered by the insulative layer 31. A thickness of the insulative layer 31 is in the range from 10 to 500 micrometers, and preferably is in the range from 75 to 200 micrometers.

After the insulative layer 31 has been deposited on the shadow mask 21, the barrier array is preferably soaked in a solution for a predetermined time to clean surfaces of the barrier array. In the preferred method, the solution comprises ethyl cellulose (85 g), butyl alcohol (60 ml) and xylene (3400 ml, 3°), and the predetermined time is 1˜5 minutes. Then, the barrier array is cured.

Because making a shadow mask is a mature technology used in CRT, this method employs the mature technology. In addition, a thickness and a material of the shadow mask 21 can be selected according to the particular requirements of the flat panel display desired. Furthermore, the thickness and the material of the insulative layer 31 can be determined according to the insulative performance required for the flat panel display. Moreover, the barrier array can be produced in a large enough size that it can be subdivided for use in a plurality of flat panel displays. In summary, the present invention provides barrier arrays having high precision with a flat upper surface and a uniform height at a low production costs, and the barrier arrays are suitable for mass production in an environmentally friendly manner.

It is understood that the invention may be embodied in other forms without departing from the spirit thereof. Thus, the present examples and embodiments are to be considered in all respects as illustrative and not restrictive, and the invention is not to be limited to the details given herein.

We claim:

1. A barrier array for use in a flat panel display comprising:
a shadow mask defining a plurality of openings therethrough according to a predetermined pattern, the predetermined pattern being in accordance with a pixel pattern of a flat panel display; and
an insulative layer formed thereon.

2. The barrier array as described in claim 1, wherein the shadow mask is made from a material selected from the group: invar, low carbon steel, or another suitable metal alloy, and the material has a coefficient of thermal expansion matching that of a substrate of a flat panel display.

3. The barrier array as described in claim 1, wherein the insulative layer comprises alumina or magnesia.

4. The barrier array as described in claim 3, wherein a thickness of the insulative layer is in the range from 10 to 500 micrometers.

5. The barrier array as described in claim 3, wherein a thickness of the insulative layer is in the range from 75 to 200 micrometers.

6. A method for making a barrier array for use in flat panel displays, comprising the following steps:
providing a metal plate;
forming a shadow mask from the metal plate by forming a plurality of openings through according to a predetermined pattern, the predetermined pattern being in accordance with a pixel pattern of a flat panel display; and
forming an insulative layer on the shadow mask.

7. The method for making a barrier array as described in claim 6, wherein the method further comprises a step of providing a mask having a pattern according to the pixel pattern of the flat panel display.

8. The method for making a barrier array as described in claim 6, wherein the metal plate is selected from the group: invar, low carbon steel, or other suitable metal alloys, and the metal plate has a thermal expansion coefficient matching that of a substrate of the flat panel display.

9. The method for making a barrier array as described in claim 6, wherein the insulative layer comprises alumina or magnesia and has a thickness in the range from 10 to 500 micrometers.

10. The method for making a barrier array as described in claim 6, wherein the insulative layer is formed on the shadow mask by spray coating.

11. The method for making a barrier array as described in claim 6, wherein the insulative layer is formed on the shadow mask by electrophoretic deposition.

12. The method for making a barrier array as described in claim 11, wherein an electrolyte employed by the electrophoretic deposition method comprises aluminum ions.

13. The method for making a barrier array as described in claim 12, wherein the electrolyte preferably comprises methyl alcohol, magnesium sulfate, aluminum nitrate, alumina and deionized water.

14. The method for making a barrier array as described in claim 11, wherein the shadow mask is used as an anode and aluminum is used as a cathode.

15. The method for making a barrier array as described in claim 6, wherein, after the insulative layer is formed on the shadow mask, preferably the shadow mask with the insulative layer formed thereon is soaked in a solution for several minutes.

16. The method for making a barrier array as described in claim 15, wherein the solution comprises ethyl cellulose, butyl alcohol, and xylene.

17. The method for making a barrier array as described in claim 15, wherein, after soaking, the shadow mask with the insulative layer formed thereon is cured.

18. A barrier array for use in a flat panel display comprising:
a metal plate defining a plurality of openings therethrough according to a pixel pattern of a flat panel display; and
an insulative layer formed thereon.

19. The barrier array as described in claim 18, wherein said openings are radially surrounded by said insulative layer.
